(19) United States
(12) Patent Application Publication
(10) Pub. No.: US 2008/0100429 A1
(43) Pub. Date: May 1, 2008

(54) TIRE PRESSURE MONITORING (TPM) AND REMOTE KEYLESS ENTRY (RKE) SYSTEM FOR A VEHICLE

(75) Inventors: Yi Luo, Ypsilanti, MI (US); Qingfeng T. Tang, Novi, MI (US); John S. Nantz, Brighton, MI (US)

Correspondence Address: BROOKS KUSHMAN P.C. / LEAR CORPORATION, 1000 TOWN CENTER, TWENTY-SECOND FLOOR, SOUTHFIELD, MI, 48075-1238, US

(73) Assignee: LEAR CORPORATION, Southfield, MI (US)

(21) Appl. No.: 11/555,366

(22) Filed: Nov. 1, 2006

(51) Int. Cl. B60C 23/00; B60R 25/00

(52) U.S. Cl. 340/447; 340/5.72

(57) ABSTRACT

The embodiments described herein include a tire pressure monitoring (TPM)/remote keyless entry (RKE) system and method for a vehicle. The system includes a TPM sensor configured to sense the condition of a vehicle tire and transmit a TPM sensor signal during a first predetermined time period. A RKE device is included that is configured to transmit a RKE signal during a second predetermined time period. Additionally, a TPM/RKE module is configured to operate in a TPM mode and a RKE mode. The TPM/RKE module receives the TPM sensor signal during the TPM mode and the RKE signal during the RKE mode. The TPM/RKE module is also configured to automatically transition between the TPM mode and the RKE mode in accordance with the first and the second predetermined time periods.

### TECHNICAL FIELD

The embodiments described herein relate to a tire pressure monitoring (TPM)/remote keyless entry (RKE) system for a vehicle having a TPM/RKE module configured to operate in a TPM mode and a RKE mode.

### BACKGROUND

Tire pressure monitoring (TPM) systems are installed on vehicles for providing vehicle occupants information relating to the condition of vehicle wheels. Remote keyless entry (RKE) systems enable remote entry to vehicles through the use of a handheld wireless devices such as key fobs. To enable the TPM and RKE functions, conventional vehicles utilize a number of electronic devices that are dedicated to either the TPM system or the RKE system. As such, some hardware redundancies exist and the cost of hardware dedicated to both TPM and RKE systems is prohibitive.

The embodiments described herein were conceived in view of these and other disadvantages of conventional TPM/RKE systems.

### SUMMARY

The embodiments described herein include a tire pressure monitoring (TPM)/remote keyless entry (RKE) system and method for a vehicle. The system includes a TPM sensor configured to sense the condition of a vehicle tire and transmit a TPM sensor signal during a first predetermined time period. A RKE device is included that is configured to transmit a RKE signal during a second predetermined time period. Additionally, a TPM/RKE module is configured to operate in a TPM mode and a RKE mode. The TPM/RKE module receives the TPM sensor signal during the TPM mode and the RKE signal during the RKE mode. The TPM/RKE module is also configured to automatically transition between the TPM mode and the RKE mode in accordance with the first and the second predetermined time periods.

### BRIEF DESCRIPTION OF THE DRAWINGS

The novel features of the described embodiments are set forth with particularity in the appended claims. These embodiments, both as to their organization and manner of operation, together with further advantages thereof, may be best understood with reference to the following description, taken in connection with the accompanying drawings in which:

FIG. 1 illustrates a vehicle having a tire pressure monitoring (TPM) system/remote keyless entry (RKE) system in accordance with an embodiment of the present invention;

FIG. 2 illustrates a detailed schematic of a TPM/RKE module that is operable with the TPM/RKE system shown in FIG. 1; and

FIG. 3 illustrates a TPM/RKE signal pattern in accordance with an embodiment of the present invention.

### DETAILED DESCRIPTION OF THE PREFERRED EMBODIMENT(S)

As required, detailed descriptions of embodiments are disclosed herein. However, it is to be understood that the disclosed embodiments are merely exemplary of the invention that may be embodied in various and alternative forms. The figures are not necessarily to scale, and some features may be exaggerated or minimized to show details of particular components. Therefore, specific functional details disclosed herein are not to be interpreted as limiting, but merely as a representative basis for the claims and/or as a representative basis for teaching one skilled in the art.

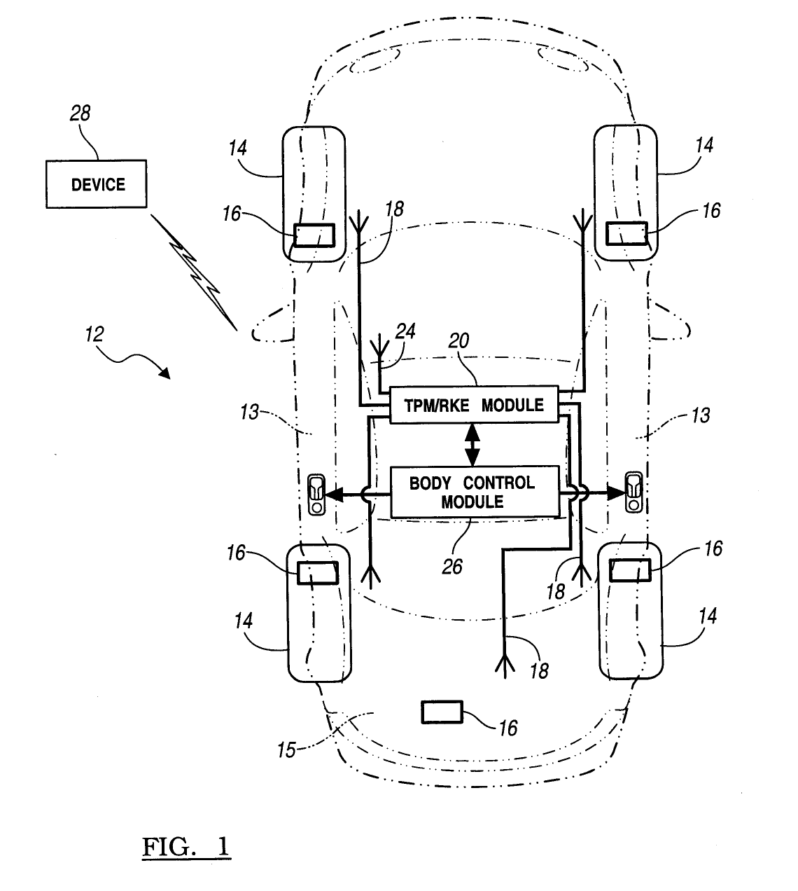

Referring to FIG. 1, a vehicle 12 is shown having a tire pressure monitoring (TPM)/remote keyless entry (RKE) system that is configured to efficiently receive, process and generate signals to effect TPM functions and RKE functions. Vehicle 12 includes doors 13, a trunk area 15 and a plurality of wheels 14 each having a TPM sensor 16. As shown, trunk area 15 may also include a TPM sensor 16 and an antenna 18. TPM sensor 16 located in trunk area 15 may be a TPM sensor that is installed within a spare tire of vehicle 12. Doors 13 allow ingress and egress to and from vehicle 12. As commonly known, doors 13 have a locked state and an unlocked state to prevent or allow entrance into vehicle 12.

TPM sensors 16 are adapted to sense the condition of wheels 14 and generate TPM sensor signals that correspond to the condition of wheels 14. In one embodiment, TPM sensors 16 do not contain an internal power supply such as a battery. During operation, a TPM/RKE module 20 generates interrogation signals that energize TPM sensors 16 causing the TPM sensors 16 to generate TPM sensor signals. TPM sensor antennas 18 enable TPM sensor signals from TPM sensors 16 to be received and processed by TPM/RKE module 20.

As described above, doors 13 have a locked and unlocked state. TPM/RKE module 20 generates control signals for a body control module 26 to generate signals causing doors 13 to enter the unlocked and locked states. TPM/RKE module 20 also includes a RKE antenna 24 for receiving RKE signals from a device 28. Device 28 may be a key fob having a plurality of buttons for unlocking and locking doors 13, starting an engine of vehicle 12, controlling various vehicle accessories and the like. When a RKE signal is generated by device 28, the RKE antenna 24 is adapted to receive the RKE signals. TPM/RKE module 20 processes the RKE signals and generate corresponding control signals for body control module 26, which generates signals for unlocking and locking doors 13. The RKE system described herein may be a two-way RKE system. As such, communications between device 28 and TPM/RKE module 20 would be bi-directional. With the two-way RKE system embodiment, in addition to locking and unlocking doors 13, device 28 may be configured to control various vehicle functions such as heating, ventilation and air conditioner (HVAC) functions and download information from vehicle 12.

TPM/RKE module 20 is also configured to receive and process TPM sensor signals and RKE signals. As described above, TPM/RKE module 20 is also configured to generate signals (referred to as interrogation signals) for TPM sensor 16 that cause TPM sensors 16 to generate the TPM sensor signals.

TPM/RKE module 20 has at least two operating modes including a TPM mode and a RKE mode. TPM/RKE module 20 is also configured to automatically transition between the TPM mode and the RKE mode. In one embodiment, the TPM mode and the RKE mode may be partitioned by time periods (e.g., a first time period and a second time period). To enable operation in the TPM and RKE mode, TPM/RKE module 20 includes a controller having data storage and processing functionality. The controller of TPM/RKE module 20 is programmed to identify the respective time periods for determining whether to operate in the TPM mode or the RKE mode. Accordingly, TPM/RKE module 20 is further configured to transition between the TPM mode and the RKE mode when either the first time period or the second time period has been reached.

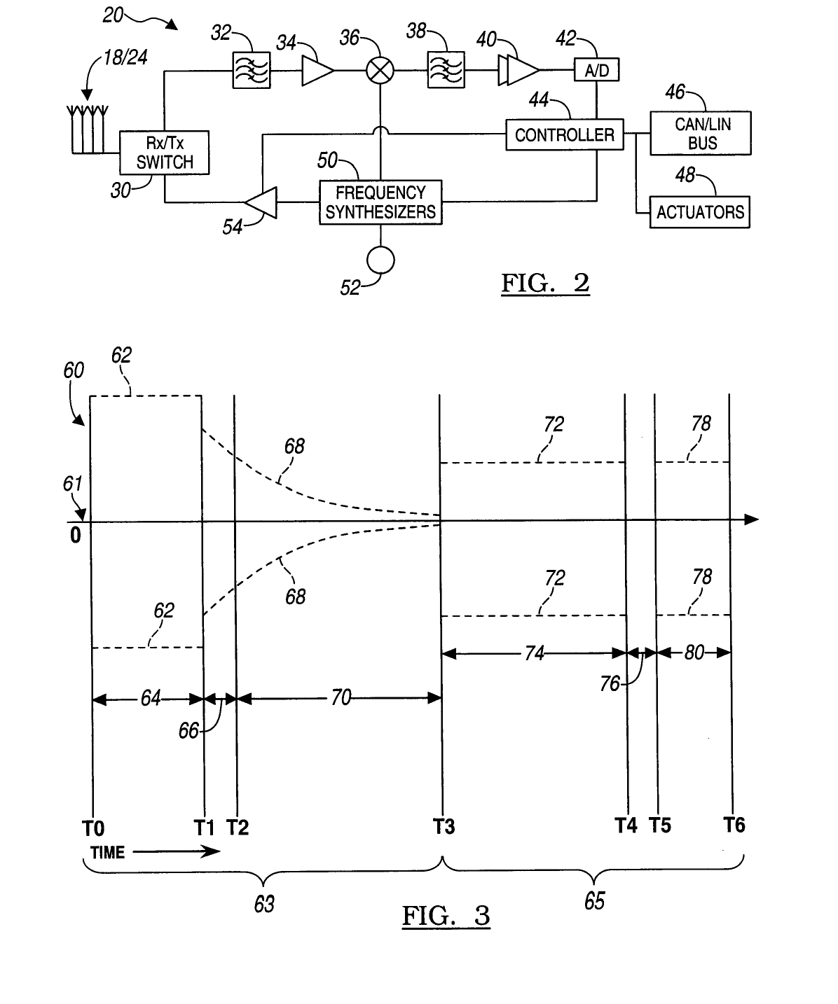

Referring to FIG. 2, a detailed schematic of an embodiment of TPM/RKE module 20 is provided. TPM sensor antenna 18 and RKE antenna 24 enable the transmission and reception of signals as described above. A switch 30 is coupled to TPM sensor antenna 18 and RKE antenna 24. Switch 30 enables the TPM/RKE module 20 to transition between transmitting and receiving signals. For example, as described above, TPM/RKE module 20 transmits an interrogation pulse signal to TPM sensors 16 (FIG. 1) thereby energizing the TPM sensor 16 and causing the generation of a TPM sensor signal. Alternatively, as the TPM sensors 16 generate the TPM sensor signals, switch 30 enables TPM/RKE module 20 to receive the TPM sensor signals for processing. Additionally, via switch 30, TPM/RKE module 20 may receive signals from a key fob (i.e., device 28 of FIG. 1).

When switch 30 is positioned to allow TPM/RKE module 20 to receive signals, the received signals are filtered by a filter 32 and amplified by low noise amplifier 34. It is recognized that the signals that are processed by filter 32 and low noise amplifier 34 typically have a high frequency. As such, to lower the frequency, a mixer 36 mixes the signals received from the low noise amplifier 34 with signals from a frequency synthesizer 50. Frequency synthesizer 50 and reference oscillator 52 provide the additional signals that, when mixed with the signal from the lower noise amplifier 34, yield a signal having a lower frequency. As such, the resulting signal from mixer 36 has a lower frequency, which is filtered by an intermediate frequency (IF) filter 38. Following filtering of the signal by filter 38, an amplifier 40 amplifies the filtered signal. An analog/digital converter 42 converts the signal from an analog format to a digital format for processing by controller 44. In the case of the TPM/RKE module 20 operating in the RKE mode, the controller 44, having received the signal from analog/digital converter 42, will generate signals for door actuators 48, via the body control module, to unlock or lock doors 13 (FIG. 1). Additionally, as shown, the signals generated by controller 44 may be transmitted throughout the vehicle via a vehicle bus 46, which may embody a controller area network (CAN) or a local interconnect network (LIN).

When switch 30 is positioned so as to allow TPM/RKE module 20 to transmit signals, controller 44 generates control signals that enable the transmission of such signals. In one aspect, during the TPM mode, TPM/RKE module 20 is adapted to generate the interrogation pulse signal for TPM sensors 16 that enable TPM sensors 16 to generate the TPM sensor signals. Alternatively, TPM/RKE module 20 may generate a module response signal in response to a RKE interrogation signal typically generated by a key fob (e.g., device 28 in FIG. 1).

Controller 44 is further configured to generate signals that are transmitted via antennas 18 and 24 in accordance with the various operating modes (i.e., the TPM mode and the RKE mode). When controller 44 generates a signal that is to be wirelessly transmitted by TPM/RKE module 20, the signal is initially amplified by a power amplifier 54. Frequency synthesizer 50 also generates a signal that is received by power amplifier 54. Accordingly, the power amplifier amplifies the signals from controller 44 and frequency synthesizer 50. The amplified signals are routed through switch 30 and transmitted by antennas 18 and 24. It is recognized that the specific arrangement of electrical components as shown by the schematic diagram of FIG. 2 may vary in alternative embodiments without departing from the scope of the present invention.

Now, referring to FIG. 3, an exemplary TPM/RKE signal pattern 60 illustrates how the TPM system and RKE system signals are generated and received during operation of the TPM/RKE system in accordance with the TPM mode and the RKE mode. The signals shown in FIG. 3 may be sinusoidal signals. An amplitude axis 61 is provided. The signal pattern 60 is shown during a TPM mode 63 and a RKE mode 65. At the beginning of TPM mode 63, during a transmitting phase 64 (between times T0 and T1), an interrogation pulse signal 62 is generated. As described above, the interrogation pulse signal 62 has sufficient energy so as to energize the TPM sensors and cause the TPM sensors to generate TPM sensor signals. In response to the interrogation pulse 62, at T1, a TPM sensor signal 68 is generated by the TPM sensors. Also, at T1 up until T2, a transmit/receive switching event occurs wherein the TPM/RKE module switches from the transmitting phase to a receiving phase to enable the reception of the TPM sensor 68.

As indicated by the “funnel” like profile, the TPM sensor signal 68 may be attenuated over time (between T2 and T3). Between the times T2 and T3, as the TPM sensor signal 68 is being transmitted by the TPM sensor, a receiving phase 70 exists wherein the TPM/RKE module receives the TPM sensor signal 68. At the time T3, which is when the first time period for the TPM mode is reached, the TPM/RKE module automatically transitions from the TPM mode to the RKE mode 65.

At T3, which starts a second time period (i.e., the RKE mode), a RKE interrogation signal 72 may be received by the TPM/RKE module. As described in the foregoing, the RKE interrogation signal may be generated by a key fob or other wireless device. The RKE interrogation signal may be a request to lock or unlock doors on the vehicle. As such, between times T3 and T4, a receiving phase 74 occurs, wherein the TPM/RKE module is adapted to receive signals. At the time T4 through T5, however, a receive/transmit switching event 76 occurs wherein the TPM/RKE module switches from the receiving phase to the transmitting phase. As such, at T5, in response to the RKE interrogation signal, the TPM/RKE module generates a module response signal 78. This module response signal, which occurs during transmit phase 80 may be received by the body control module so as to cause the body control module to generate signals that unlock doors on the vehicle.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A tire pressure monitoring (TPM)/remote keyless entry (RKE) system for a vehicle comprising:
a TPM sensor configured to sense the condition of a vehicle tire and transmit a TPM sensor signal during a first predetermined time period;
a RKE device configured to transmit a RKE signal during a second predetermined time period; and
a TPM/RKE module being configured to operate in a TPM mode and a RKE mode, the TPM/RKE module receiving the TPM sensor signal during the TPM mode and the RKE signal during the RKE mode, the TPM/RKE module being configured to automatically transition between the TPM mode and the RKE mode in accordance with the first and the second predetermined time periods.

2. The system of claim 1, wherein the TPM sensor includes a TPM sensor that is void of an internal power source.

3. The system of claim 1, wherein the TPM/RKE module generates an interrogation pulse signal for the TPM sensor during the TPM mode.

4. The system of claim 3, wherein the TPM sensor is configured to generate TPM sensor signals in response to the interrogation pulse and the TPM/RKE module is configured to receive the TPM sensor signals.

5. The system of claim 4, wherein the generated TPM sensor signals include data relating to the condition of at least one wheel of the vehicle.

6. The system of claim 1, wherein the TPM/RKE module includes a controller, wherein the TPM/RKE module automatically transitions between the TPM mode and the RKE mode when the controller determines that the either one of the first predetermined time period or the second predetermined time period has been reached.

7. The system of claim 1, wherein the TPM/RKE module receives a RKE interrogation signal during the RKE mode.

8. The system of claim 7, wherein the TPM/RKE module generates a module response signal in response to the RKE interrogation signal.

9. The system of claim 1, wherein the TPM mode and the RKE mode each include a transmitting phase for the TPM/RKE module to transmit signals and a receiving phase for the TPM/RKE module to receive signals.

10. A method of operation for a tire pressure monitoring (TPM)/remote keyless entry (RKE) system for a vehicle, wherein the TPM/RKE system includes a TPM/RKE module, the method comprising:
configuring the TPM/RKE module to operate in a TPM mode and a RKE mode;
transmitting a TPM sensor signal during a first predetermined time period;
transmitting a RKE signal during a second predetermined time period; and
receiving the TPM sensor signal during the TPM mode;
receiving the RKE signal during the RKE mode; and
transitioning automatically between the TPM mode and the RKE mode in accordance with the first and the second predetermined time periods.

11. The method of claim 10, wherein the TPM sensor includes a TPM sensor that is void of an internal power source.

12. The method of claim 10, further comprising generating an interrogation pulse signal for the TPM sensor during the TPM mode through the use of the TPM/RKE module.

13. The method of claim 12, further comprising generating the TPM sensor signals in response to the interrogation pulse.

14. The method of claim 13, wherein the generated TPM sensor signals include data relating to the condition of at least one wheel of the vehicle.

15. The method of claim 10, wherein the TPM/RKE module includes a controller, wherein the TPM/RKE module automatically transitions between the TPM mode and the RKE mode when the controller determines that the either one of the first predetermined time period or the second predetermined time period has been reached.

16. The method of claim 10, further comprising receiving a RKE interrogation signal during the RKE mode.

17. The method of claim 16, further comprising generating a module response signal in response to the RKE interrogation signal.

18. The method of claim 10, wherein the TPM mode and the RKE mode each include a transmitting phase for the TPM/RKE module to transmit signals and a receiving phase for the TPM/RKE module to receive signals.

19. A tire pressure monitoring (TPM)/remote keyless entry (RKE) system for a vehicle comprising:
a TPM sensor configured to sense the condition of a vehicle tire and transmit a TPM sensor signal during a first predetermined time period, wherein the TPM sensor is void of an internal power source;
a RKE device configured to transmit a RKE signal during a second predetermined time period; and
a TPM/RKE module being configured to operate in a TPM mode and a RKE mode, the TPM/RKE module generating an interrogation pulse signal for the TPM sensor and receiving the TPM sensor signal during the TPM mode, the TPM/RKE module receiving a RKE interrogation signal and generating a module response signal in response to the RKE interrogation signal during the RKE mode, wherein the TPM/RKE module is configured to automatically transition from the TPM mode to the RKE mode when the first predetermined time period has been reached and to automatically transition from the RKE mode to the TPM mode when the second predetermined time period has been reached.

20. The system of claim 19, wherein a transmit/receive switching event occurs between the generation of the interrogations pulse signal and the reception of the TPM signal during the TPM mode; and
wherein a receive/transmit switching event occurs between the reception of the RKE interrogation signal and the generation of the module response signal during the RKE mode.
